(19) United States
(12) Patent Application Publication
(10) Pub. No.: US 2026/0244695 A1
(43) Pub. Date: Aug. 20, 2026

(54) ELECTRONIC REPRESENTATION OF A LOCATION OF A DEVICE PERFORMING A SEARCH

(71) Applicant: SEO Local LLC, South Jordan, UT (US)

(72) Inventor: Russell S. Thornton, South Jordan, UT (US)

(21) Appl. No.: 19/430,714

(22) Filed: Dec. 23, 2025

Related U.S. Application Data
(60) Provisional application No. 63/760,035, filed on Feb. 18, 2025.

(51) Int. Cl. G06F 16/9537; G06F 16/954

(52) U.S. Cl. CPC G06F 16/9537; G06F 16/954

(57) ABSTRACT

Technology is described for defining an electronic representation of a location for a device, located in a distributed network, to perform a search for an organization. The method can include disabling wireless communications for the device in a distributed network or hardware farm. A local geographic region associated with an organization location can be defined where the device will represent the device as being located, using a user interface. An IP address and location of the device may be set representing the local geographic region associated with an organization location using a virtual private network (VPN). Another operation is executing a search with keywords related to the organization location through a web browser on the device. A URL may be activated in search results for the organization location within the geographic region.

### PRIORITY DATA

This application claims the benefit of U.S. Provisional Application No. 63/760,035, filed February 18, 2025, which is incorporated herein by reference.

### BACKGROUND

Search engine optimization (SEO) is a term describing the situation where web site owners work to improve the quality and quantity of internet traffic to their website or web pages from electronic search engines (e.g., Google, Bing, Yahoo, Baidu, DuckDuckGo, etc.). Higher rankings in search engine results generally result in increased traffic to a website and ideally increased visibility, traffic and/or income for a business. One objective of SEO is to obtain unpaid search traffic (e.g., organic results) rather than direct traffic, referral traffic, social media traffic, or paid traffic (e.g., obtained through online advertising or electronic advertising). Unpaid search engine traffic may originate from many kinds of searches, including key word searches, image searches, video searches, academic searches, news searches, or industry specific search engines.

As an internet marketing strategy, SEO considers: how search engines work, what people search for, what actual search queries or keywords are typed into search engines, how the computer-programmed algorithms dictate search engine results, and which search engines are preferred by a target audience. SEO is performed because a website may receive more visitors from a search engine when websites rank higher within a search engine results page (SERP), and a goal may be either converting the traffic or building brand awareness.

### BRIEF DESCRIPTION OF THE DRAWINGS

FIG. 1 is a block diagram illustrating an example of defining an electronic representation of a location for a device performing a search for an organization.

FIG. 2 is an example of a user interface screen illustrating a polygon drawn around an organization’s location.

FIG. 3 is a screen from a web application showing the keywords that may be used for performing automated searching.

FIG. 4 is a screen illustrating click counts executed for individual keywords.

FIG. 5 illustrates that a search ranking of a business location may be increased due to automated activity of the devices in the device farm.

FIG. 6 is flowchart illustrating an example of a method for defining an electronic representation of a location for a device performing a search for an organization.

### DETAILED DESCRIPTION OF THE PREFERRED EMBODIMENTS

Reference will now be made to the examples illustrated in the drawings, and specific language will be used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure, are to be considered within the scope of the description.

Ranking high in search engine results for search terms related to a website owner’s business, may generally be important to the business or website. Increases in search engine rankings can often result in increases in revenue for a business. For example, ranking atop a search engine (e.g., Google) map pack is valuable for local organizations because ranking high in the map pack offers visibility to potential customers. A map pack may be the few businesses (two or three business) that are shown at the top of a search engine’s search results with a map showing the business’ locations. When users search for local services or products, the map pack appears at the top of the search results, capturing immediate attention. Organizations in a map pack may receive 126% more traffic than organizations ranked 4-10 in the map pack.

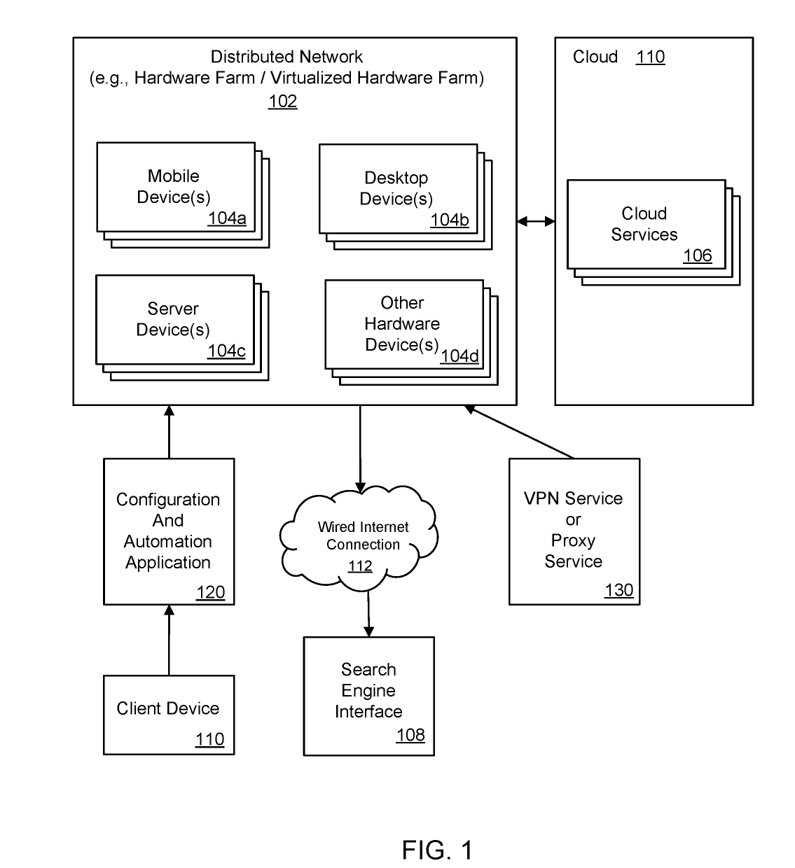

This technology provides a system and method for defining an electronic representation of a location for a device or hardware device that can perform a search through a search engine for an organization’s website. FIG. 1 illustrates groups of devices 104a-d which may be located in a distributed network 102. For example, the distributed network 102 may be a hardware farm or a virtualized hardware farm in a public or private cloud. In another example, some hardware devices may be in a distributed network that is a local network in a specific geographic region. Some devices 104a-d in a distributed network may be located in a first area or network, while other hardware devices may be hosted in the cloud in a hardware farm. The hardware farm may contain, for example, mobile devices 104a (e.g., tablets), desktop devices 104b (e.g., laptop devices), server devices 104c, and other hardware devices 104d that may be remotely controlled, remotely communicated with and programmed to take automated actions. These hardware devices may each have a wired connection to a network or virtual network managed by the hardware farm 102. For example, the devices can be connected to the internet using a wired network connection and a software port.

The hardware farm 102 may be in communication with a cloud 110 to access cloud services 106, if desired. However, access to the cloud 110 by the hardware farm 102 is optional. The cloud may be a public service provider cloud, a private cloud or simply a data warehouse.

Remote actions may be executed on devices 104a-d in the hardware farm 102. A configuration and automation application 120 may be used by a client device 110 to execute remote actions (e.g., using scripts) on the devices 104a-d in the hardware farm 102. For example, the configuration and automation application 120 may reside on the client device 110, reside on a separate device (e.g., a server) or reside in a service provider system (e.g., a separate cloud) but be controlled by the client device 110.

In one embodiment, the hardware farm may be a virtualized hardware farm 102. Virtualized instances of operating systems that typically execute on a hardware device (e.g., a mobile phone, mobile tablet, laptop, etc.) may execute on a virtualization layer, such as hypervisor for virtualizing the operating systems. For example, virtual devices can be created in an Android OS emulator on an AWS EC2 instance and the UDID in the configuration can be randomized or copied from a defunct piece of hardware in order to provide a unique virtualized instance to perform the search functions described in this description. In some configurations, virtualization may not be as efficient in terms of speed or cost, but that may vary depending on the virtualization implementations or underlying hardware used for the virtualization.

An application may be installed on a device in the hardware farm which provides access to native settings of the device. The device may be a mobile device 104a, a desktop device 104b, server device 104c or another hardware device 104d. A developer mode may be activated in the device (e.g., 104a) that is wired to a computer network which provides access to native settings of the device. For example, this technology may use a configuration and automation application 120 (e.g., Appian loaded on a cloud server), to install the automation scripts and APK(s) (i.e., an Android package) on Android devices.

In order for a device to be used for localized actions, the wireless communications of the device must first be disabled. The device may be a mobile device 104a or another type of device in the hardware device farm 102. The wireless communications that are disabled may be Wi-Fi connections, Bluetooth connections, cellular or any other wireless connections. The APKs include functionality which has the ability to disable the Wi-Fi, the Bluetooth, cellular connection or other wired connections. A cellular connection is less likely to need to be shut down because the Android device will not generally have SIM card or e-SIM card but if a cellular connection exists, then the cellular connection can be shut down.

The configuration and automation application 120 may then set a virtualized IP location based on a VPN service 130 the device is connected to. Alternatively, a proxy service or proxy server can be used for provisioning local IP addresses. Next, the device may perform the searches and the search engine (e.g., Google) analytics picks up the searches.

In this technology, a local geographic region associated with an organization location may be defined. The device can represent itself as being located within or near that local geographic region. In other words, the hardware devices may represent themselves as being virtually located in the local geographic region even though the hardware devices are not physically located in the local geographic region. More specifically, the devices may be physically located in a distributed network 102 outside the local geographic region. In other words, the device implies the device’s location using the IP address and settings that are likely to be referenced to geolocation databases or services which map IP address blocks to the locations where they are primarily used (e.g., by an ISP's network infrastructure). The setting of the local geographic region may be performed by a user using a user interface. For example, the setting of the local geographic region may be done through a web application. Alternatively, the local geographic region may be set in an application on a mobile device or desktop computer. Then the local geographic region may be communicated to a centralized application, such as the configuration and automation application 120 or a cloud service with functionality to store and report the geographic region being represented by the device.

The local geographic region to be used by the device (e.g., for using IP addresses associated with that geographic region) may be defined by graphically defining the geographic region, numerically setting a radius of the geographic region around the organization’s location or setting the geographic region using a user interface. For example, the geographic region may be set using any shape (e.g., a geometric shape such as: a polygon, a circle, a square, a triangle, or an irregular shape, etc.) around or near a location of the organization location, setting a distance radius for a shape around a location of the organization location being searched for or by defining a shape in proximity to the organization location.

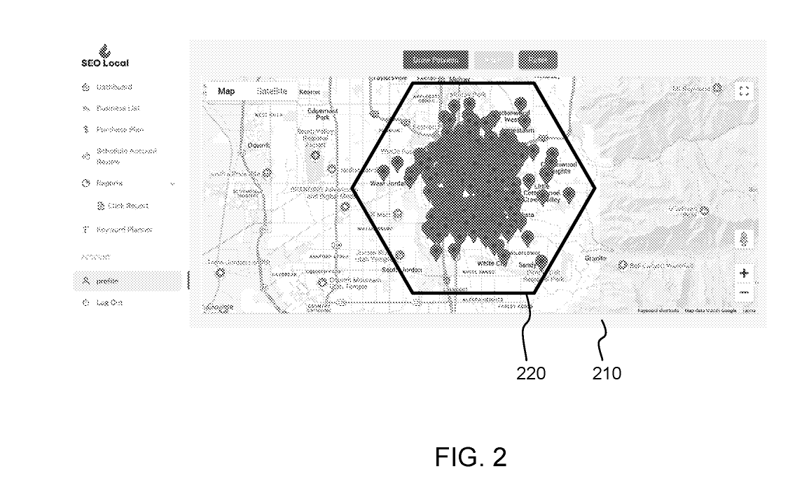

FIG. 2 is an example of a user interface screen 120 illustrating a polygon 220 drawn around an organization location. The IP addresses that are used for the device may also IP address associated (e.g., in or very near to the area) with the area drawn around the organization location.

An IP address and location of the device in the hardware farm may be set to represent that the device is in the local geographic region associated with an organization location. The IP address of the device may be set using a virtual private network (VPN) or a proxy server. The location of the device may be set by changing settings of the device, and the location may be set using a developer mode for the device. The IP address and location may virtually represent a different location in proximity to the organization location than an actual physical location of the device. Setting the location may further include setting a longitude and latitude for the device.

Once the IP address and location have been set, a search may be executed by the device with keywords related to the organization location through a web browser on the device. In one example, the keyword searches may be performed using scripts sent to the device. For example, the search may be for “Auto Parts Store” in San Diego, California.

This framework uses keywords that are searchable and provides the action (e.g., mouse clicks or other user interface activations for executing functions) for searchable keywords. Some keywords might not searchable and may not be used by the search engine. The keywords that are searchable may be aligned with organic header keywords or H2 second level headings on a website. These organic keywords are generally used as headers and navigation links on the website.

The searches are not limited to keyword searches only. For example, the searches may include other types of searches such as image searches, video searches, academic searches, news searches, industry specific search engines or any other type of searches that may result in finding of the organization location.

A URL in the search results from the search can be activated for the organization location within the geographic region. For example, the URL for the “Auto Parts Store” may be found in the search result. Then the URL for the organization or organization location may be activated or “clicked on” by the automation software. When the automation software activates links through a browser, then the search engine registers local organic search activity for that URL.

Further, a plurality of web pages may be navigated to, which are accessible through the URL of the organization location. The search engine may then register this web page activity as part of the local search activity. The navigation of the web browser, accessing maps, appointment setting, or other organization location related actions may be performed using at least one of a process, an application or an agent executing on the device in the hardware farm.

Part of activating search results can be navigating to a map for a location of the organization location or to an appointment setting application for the organization location. The map, the appointment setting application or another organization location related application (or web application) may be presented in the results from the search engine being used. Using a localized device to navigate to a map for the location of the organization or an appointment setting application, increases the localized interest shown in the business and can increase the search ranking for the business.

The process described may be applied with a plurality of devices. For example, there may be tens, hundreds or thousands of devices used from the hardware farm to perform the localized search activities. Each of the plurality of devices may be a unique device. Otherwise, the search engine(s) generally ignore the activity of devices that do not have unique hardware identifiers.

As discussed above, a device farm technology or a device farm layer is provided. The device farm may be accessed through a cloud or through a computer network (e.g., the internet). For example, a framework called Appium or a similar device automation framework can be used to automate applications and devices in the device farm. Appium is a mobile automation tool which is used to automate mobile applications on different mobile operating systems such as Android and iOS. Appium is an open source tool which can sometimes be used to automate the use or testing of different mobile device applications such as native, WAP (wireless application protocol) and hybrid applications. The device farm may include any number of devices that can be setup and used in the device farm.

Device farms have previously been used for testing applications, but device farms have not been used to increase SEO rankings in the past. The use of a device farm enables the system to work with the search engine algorithm (e.g., Google, Bing, etc.), by providing organic searches that are associated with a geographic location of an organization location or business location. In addition, the use of the device farm may enable thousands of devices to provide a large volume of localized activity to a search engine with the device farm. Prior device farms cannot provide this functionality because the hardware devices do not have location modification for the device. As discussed, the system can install an app on the mobile devices in the device farm that enables automation to take place using the mobile device. The application can also allow the IP address of a mobile device to be updated using a VPN or a proxy server and a location may be set by the application.

In one example of using the present technology, a customer may be interested in increasing local traffic that a search engine is receiving for their localized business. If the primary keyword is a “paint store”, the paint store chain may have at least two separate locations. For example, one specific paint store may be in the Salt Lake City, Utah area. The user may provide or select the specific paint store location through a graphical user interface. The user may then draw any graphical shape (e.g., a polygon, gesture lines) or other geographic guidance that targets a specific area around or near the paint store location. This enables the system to determine the IP addresses to be used for the device. The application can set the IP and the location to be in this specific radius that was define using a graphical shape or geographic guidance.

Alternatively, the local geographic region may be defined by a process. For example, the local geographic region may be defined by an estimated distance from the organization location or areas automatically selected on a map by a process and the areas are near to the organization location.

In the example being discussed above, a number of the devices in the hardware farm may be launched (e.g., the hardware farm spins up the devices) and the devices can begin to search for the paint store and activate the localized paint store URL. For instance, 10, 100 or 1000 devices may be used. The searches may use keyword searches and then a main URL (e.g., a local home page) associated with the organization location or business may be activated. The device may perform keyword searches such as “custom paint”, “car paint”, or “custom car painting”.

The IP addresses of the devices are set to an IP address that is considered to be within the boundary that was indicated by a user, and the location of the device is also set to be within the boundary. Returning to the paint store example above, the VPN can be used look up Salt Lake and Utah county IP addresses so that the IP addresses used are believed by others to be within the boundary drawn. It is possible the IP addresses may be a little outside the boundary, if desired, but they may be a defined distance outside the boundary (e.g., 10% or 20% of the distance of a radius of the drawn object).

Even though IP addresses are not inherently tied to a specific geographic location, the way IP addresses are managed and routed allows geolocation services to make an estimation about the approximate location of a device based on its IP address. This process is known as IP geolocation. IP addresses may be considered to be from a location, even if it is not a precise mapping for at least a few reasons. First, IP addresses are allocated in large blocks to RIRs, which then further assign smaller blocks to Internet Service Providers (ISPs) and other organizations within their respective service regions. Second, ISPs assign these IP addresses to their customers (either dynamically or statically). The IP address itself does not necessarily contain geographical data. Instead, geolocation databases map these IP address blocks to the locations where they are primarily used by the ISP's network infrastructure. This could be the location of a server, a network hub, or even the ISP's headquarters. Third, IP geolocation services use such databases to analyze an IP address alongside routing information and other data to determine an approximate location. By analyzing where an IP address block is registered and how internet traffic from that IP is routed, geolocation services can infer a general location. The present technology uses these assumptions to allow a device to represent that the device is in a different location than the devices actual location.

Search engines (e.g., Google) track the UDID (Universal Device Identifier) or hardware serial number of hardware devices that are accessing the search engine. The search engines have defined that a local search from a device cannot the same UDID or hardware serial number more than once in roughly 24 hours or that UDID or hardware serial number may be ignored. Accordingly, the devices used for automated actions may be rotated across many different devices (e.g., hundreds or thousands of devices) in the device farm.

This technology allows users to activate devices in a hardware farm and use an automation app (e.g., Appian) to configure and set the settings of the individual devices in the hardware farm so that the devices are identified as being in a different geographic location than their physical location. This way software, services (e.g., search engines) or devices which are tracking the location of the active devices or searching devices on the Internet receive information that implies the device is at a different location than the physical device location.

The physical device farm may be located anywhere in the world. For example, the device may be in India or Vietnam and still be able to perform actions in other countries. There may be tens, hundreds or thousands of physical devices in each device farm location.

As discussed, this technology can provide local traffic and local searches using website clicks. An additional function may be the ability to click on the directions or maps provided by a search engine or log calls made to a business with a website. There may additional functions that the search engine provides in the future that allows the device to perform additional localized functions and this technology may be able use any localized functions as they become available.

Obtaining additional local traffic may enable a business to increase their search engine rankings within a few months, depending upon the other market competition. A business’ search result ranks may increase to be as high as the top 2 to 5 in rankings in a local market.

In the past, users of a hardware farm have sent software to a hardware farm so that the software can be executed on devices in the hardware farm. When the software executes on the device on the hardware farm, this tests the software product on the device, then returns with any reports or problems (e.g., compatibility problems, bugs, etc.) that exist with the software. This has also allowed developers to quickly test their software on many types or mobile, networking or other devices. Hardware farm technology has also been used for posting thousands of blog content postings to post a job or postings to comment postings to social media. In contrast, the present technology uses the hardware farm to generate localized activity on the Internet or through search engines for a localized website returned in a search result.

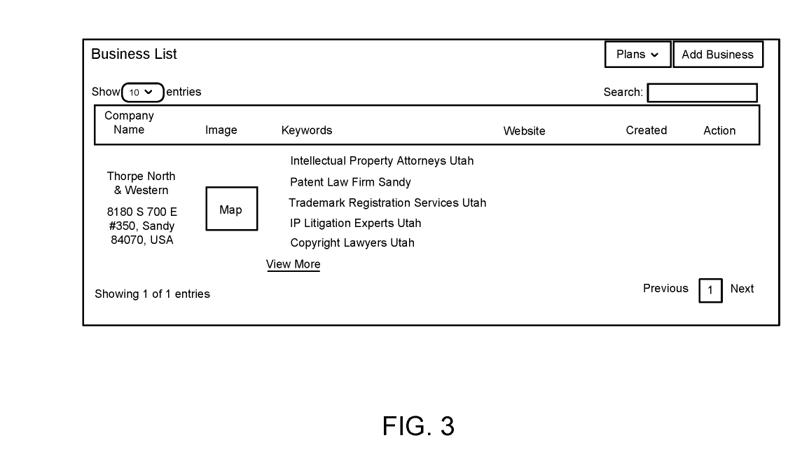

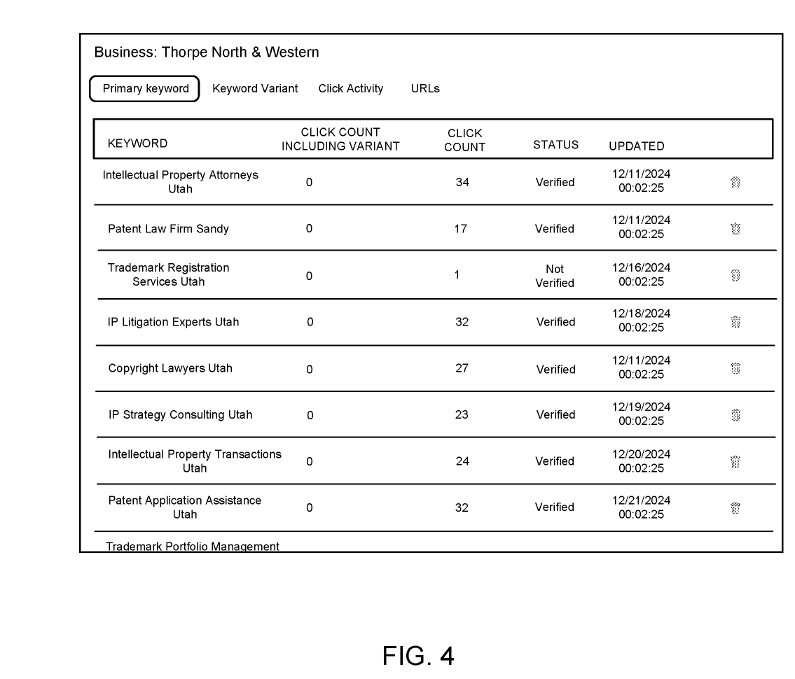

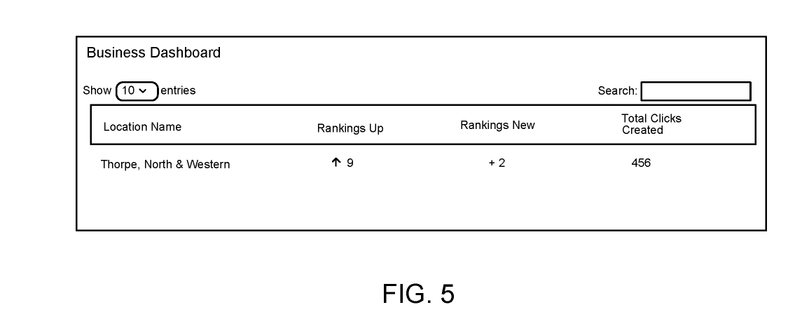

FIG. 3 is a screen from a web application showing the keywords that may be used for performing the automated searching. FIG. 4 is a screen illustrating click counts for individual keywords. FIG. 5 illustrates that a search ranking of a business location may be increased due to automated activity of the devices in the device farm.

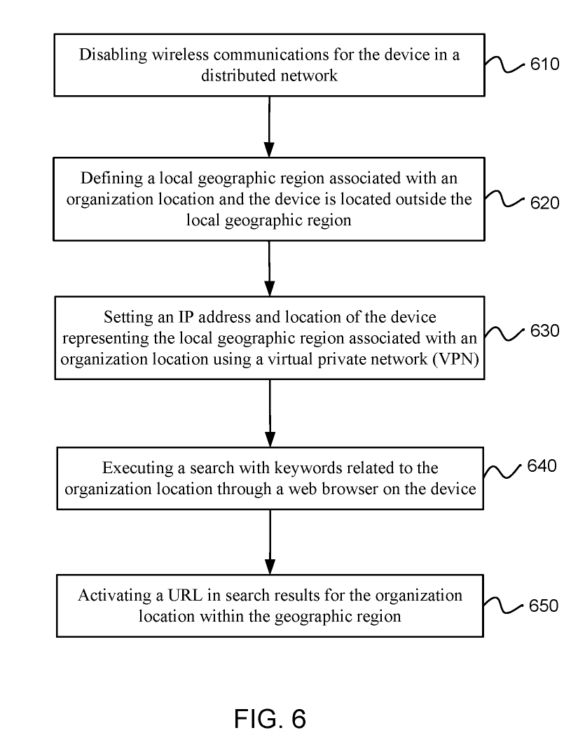

FIG. 6 illustrates a flowchart of a method for defining an electronic representation of a location for a device, physically located in a hardware farm, to perform a search for an organization. The device may be a mobile device, a laptop device, a tablet, a desktop device, a server or another device. The device may be in a device farm and may be connected to the internet using a wired network connection.

The device farm may have tens, hundreds, thousands or more devices. Each of these devices may be a unique hardware device (e.g., a unique mobile phone, unique tablet, unique laptop, etc.). The devices may be connected to the Internet using a physical connection (e.g., a physical cord) to a router to network of all these different hardware device (e.g., phones) to the internet. For example, the device may be connected via a cord and hardware port, so that the device has an IP network connection or IP network address from the hardware farm that allows the device to reach the VPN or proxy server and obtain the localized IP address. The hardware port may enable USB debugging and execution of apps through Appium and Android Studio directly or other IDEs that may be used.

The method may include disabling wireless communications for the device in a hardware farm, as in block 610. Wireless communications that are disabled may be the Wi-Fi connections, Bluetooth connections, cellular connections or other wireless connections.

In the device farm, the mobile devices may be in a rack but each device is a unique hardware device with a unique hardware address. A browser automation framework (e.g., the Selenium framework) may be launched on each of the devices to be able to execute the desired web functions (e.g., web searching and web navigation as described earlier).

A local geographic region associated with an organization location can be defined, and this local geographic region is where the device will represent itself as being located or imply that it is located using an IP address, as in block 620. The device may be physically located in a distributed network outside the local geographic region and may represent that the device is virtually located in the local geographic region. The local geographic region may be defined using a user interface, shown earlier. A local geographic region may be defined by: setting a shape (e.g., a geometric shape) around a location of the organization location, setting a distance radius around a location of the organization location or by defining a shape in proximity to the organization location.

The user can identify the business location and its geographical coordinates. A graphical object or shape that is drawn around the organization location or a numerical radius distance that is set by a user can provide a radius for where devices should represent themselves as being located to improve the search results for the organization location. A search engine (e.g., Google) algorithm uses a business profile that ties the organization to a registered business address, which a user can see in the search engine’s data store. Any URL activations, actions or clicks are more relevant if they are within a 10 mile distance of the organization’s registered business address (e.g. registered with the search engine). If the clicks or activations are at 100 or 150 miles, then the actions or clicks may be treated as basic organic desktop action and the organization may not get the desired GMV (gross merchandise value) or local map pack rating that is relevant for the automated device activity.

An IP address and location of the device may be set representing the local geographic region associated with an organization location using a virtual private network (VPN) or a proxy server, as in block 630. Setting the location may include setting a longitude and latitude for the device. The IP address and location may virtualize or represent a different location in proximity to the organization location, as compared to an actual physical location of the device. The IP address and location of the device may also be set using other services that can modify geo-location attributes such as Smart DNS or a secure web gateway (SWG).

An application may be installed on the device which provides access to native settings of the device that can be changed as described above. The application for changing settings may be an APK that is loaded and provides access to the native settings of an operating system (e.g. Android) of the device. The IP address and the location may be set using a developer mode for the device, which provides access to native settings of the device. For example, an APK file can be remotely installed on an Android OS mobile device or an IPA (iOS App Store Package) can be remotely installed on iOS mobile device. The APK or its equivalent may provide access to the native settings in the Android OS. This means the hardware device has been switched into a developer mode. The developer mode may be used set an IP address and location that is different than the device’s actual physical location. This may be considered a virtual IP address and location.

A revised or virtualized IP address used to connect to the internet or a network can then be obtained using a VPN or a proxy server. A VPN can provide an IP address from another location by routing the internet traffic through a remote server operated by the VPN provider. This process can provide hundreds or thousands of IP addresses, at practically any implied location in the world. Once the IP address is set to be in a certain city or location, then the latitude and longitude of the device can be set in advance of a search and any activations or clicks. This setup provides a virtualized location or implied location for the origination of the searching and clicks. These devices may know where to set their location by pulling from the location already set using the map received from the user.

When the device performs a web search using the device, then the device may scroll the search engine profiles and activate (e.g., click on) the website. The device can go to the website and access one or more web pages. For example, a mobile device can have its own location set to be within a radius or defined distance around a target business. Then the mobile device may perform a keyword search for that business. The search engine profiles can be scrolled through and the device can activate (e.g., click) the website URL. The device can go to the website and then access one or more web pages. When the correct business is returned and identified in the search engine results, the automation software may activate or click on the business profile and browse through some pages. The resulting outcome is that over the next few weeks the ranking of the business “found” through the search engine (e.g., on Google) may rise steadily and quickly.

For example, a search may be executed with keywords related to the organization location through a web browser on the device, as in block 640. The keyword searches may be performed using automation scripts sent to the device and then launched or executed on the device. For example, the keyword searches may use Python scripts to perform the keyword searching actions through the automation application that was loaded as an APK. The application can execute a script to open the XBOT script for a web browser (e.g., Chrome) and maps. The script uses XBOT to go through the commands. The XBOT script looks for a specific organization location profile on the page for the SEO improvement campaign.

A URL may be activated in search results for the organization location within the geographic region, as in block 650. A plurality of web pages that are accessible through the URL may also be navigated through or accessed. These may be web pages that are accessible from the home page of the organization location. In addition, the device may navigate to a map for the organization location or to an appointment setting application. The navigation of the web browser and maps may be performed using a process, an application or an agent executing on the device in the hardware farm.

When there are thousands of devices that provide localized interactions for a website of a business, then the search ratings start to move higher due to the clicks that are implied as being within a local distance of the organization location. Changing the location settings and networking addresses of the actual hardware devices that are in a hardware farm allows traffic to be provided to a search engine for an organization that is implied as being in and/or focused on a local area.

The modified devices might also be used for testing (e.g., load testing or regression testing) of network traffic to search engines or an organization website. Other uses of this technology may include the ability to access a website using different settings or languages on a device or government intelligence collection work. This technology may allow for the testing of a group of devices that appear to be in a different location than the devices physical location. This may assist with testing of network functions where the networking traffic is desired to be sent to different places in the world (e.g., via a VPN or proxy server) but the mobile device is in the device farm.

An organization that wants to have local traffic execute against their website can purchase a monthly subscription to have hundreds of devices that represent themselves as being a local device and perform actions on the organization’s website. For example, tens, hundreds or thousands of devices may take actions within a 3 mile radius, a 5 mile radius or a 10 mile radius. Similarly, an organization may subscribe for 1200 searches, 3000 searches and 9000 searches a month.

Increases in rankings for an organization’s website may be able to be tracked using website search ranking tools. For example, BrightLocal may be used as a Google search ranking aggregation tool that does keyword validation and grid ranking points. This tool enables tracking of a website ranking without have to access the Google “my business profile” on the web. If the devices do not keep providing local actions over time then the search rankings of the organization’s website will likely drop because search engines rank local websites based on recent active search traffic.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

1. A method for defining an electronic representation of a location for a device to perform a search, comprising:
defining a local geographic region associated with an organization location, wherein the device is located in a distributed network outside the local geographic region;
setting an IP address and location of the device representing the local geographic region associated with an organization location using a virtual private network (VPN) or proxy server to electronically represent the device as being located in the local geographic region;
executing a search with keywords related to the organization location through a web browser on the device; and
activating a URL in search results for the organization location within the geographic region.

2. The method as in claim 1, further comprising disabling wireless communications for the device in the distributed network.

3. The method as in claim 2, further comprising disabling wireless communications that are at least one of Wi-Fi connections, Bluetooth connections or cellular connections.

4. The method as in claim 1, further comprising navigating to a plurality of web pages that are accessible through the URL in order to provide traffic for the URL.

5. The method as in claim 1, further comprising navigating to a map for a location of the organization location or to an appointment setting application.

6. The method as in claim 1, wherein the application is an APK that provides access to all native settings of an operating system of the device.

7. The method as in claim 1, wherein the device is a mobile device, a laptop device, a tablet, a desktop device, or a server.

8. The method as in claim 1, wherein the device is connected to an internet using a wired network connection.

9. The method as in claim 1, wherein the IP address and location are set using a developer mode for the device.

10. The method as in claim 1, further comprising setting a longitude and latitude for the device.

11. The method as in claim 1, wherein defining a local geographic region is further defined by: setting a shape around a location of the organization location, setting a distance radius around a location of the organization location being searched for or by defining a shape in proximity to the organization location.

12. The method as in claim 1, wherein the keyword searches are performed using scripts sent to the device.

13. The method as in claim 1, wherein navigation of the web browser and maps is performed using at least one of a process, an application or an agent executing on the device.

14. The method as in claim 1, wherein the IP address and location represent a different location in proximity of the organization location than a physical location of the device.

15. The method as in claim 1, further comprising installing an application on the device which provides access to native settings of the device.

16. The method as in claim 1, further comprising activating developer mode in the device that is wired to a computer network which provides access to native settings of the device.

17. A non-transitory computer readable storage medium having instructions embodied thereon, the instructions when executed by one or more processors, cause the one or more processors to perform a process for defining an electronic representation of a location for a device performing a search, including:
disabling wireless communications for the device in a distributed network;
defining a local geographic region associated with an organization location using a user interface, wherein the device is located in a distributed network outside the local geographic region and represents the device as being virtually located in the local geographic region; setting an IP address and location of the device representing the local geographic region associated with an organization location using a virtual private network (VPN) or proxy server;
executing a search with keywords related to the organization location through a web browser on the device; and
activating a URL in search results for the organization location within the geographic region.

18. The method as in claim 17, further comprising navigating to a plurality of web pages that are accessible through the URL.

19. A system, comprising:
at least one processor;
at least one memory device including a data store to store a plurality of data and instructions that, when executed, cause the system to:
disable wireless communications for the device in a distributed network;
define a local geographic region associated with an organization location using a user interface, wherein the device is located in a distributed network outside the local geographic region and will represent the device as being located in the local geographic region;
set an IP address and location of the device representing the local geographic region associated with an organization location using a virtual private network (VPN) or proxy server;
execute a search with keywords related to the organization location through a web browser on the device; and
activate a URL in search results for the organization location within the geographic region.

20. The system as in claim 19, further comprising navigating to at least one of: a plurality of web pages that are accessible through the URL, a map for a location of the organization location or to an appointment setting application.
